(19) United States
(12) Patent Application Publication
(10) Pub. No.: US 2026/0185404 A1
(43) Pub. Date: Jul. 2, 2026

(54) PORTABLE SAFETY LADDER

(71) Applicant: KOREA OCCUPATIONAL SAFETY & HEALTH AGENCY, Ulsan (KR)

(72) Inventors: Jong Moon HWANG, Ulsan (KR); Kyung Boo CHANG, Ulsan (KR); Hyun Kyung YOON, Ulsan (KR); Ki Yeol LEE, Gwangju (KR); Du Sung JEON, Gyeonggi-do (KR)

(21) Appl. No.: 18/862,955

(22) PCT Filed: May 16, 2023
(86) PCT No.: PCT/KR2023/006574

§ 371 Date: Nov. 5, 2024

(30) Foreign Application Priority Data
May 4, 2023 (KR) 10-2023-0058199

(51) Int. Cl. E06C 1/393; E06C 1/22; E06C 1/397; E06C 7/18; E06C 7/42

(52) U.S. Cl. CPC E06C 1/393; E06C 1/22; E06C 1/397; E06C 7/182; E06C 7/183; E06C 7/423

(57) ABSTRACT

A portable safety ladder comprising: a ladder body including a first frame and a second frame that, when the ladder is unfolded, are spread apart from each other about an upper hinge axis and when the ladder is folded, are completely folded about the hinge axis; and an upper safety rail provided in a loop shape on an upper portion of the ladder body, wherein the upper safety rail is provided above a pair of base members that are assembled to move up and down with respect to the first frame, and the upper safety rail is provided in a rotary type, so that when the ladder is folded, the upper safety rail is completely folded toward the second frame side and comes into close contact with the second frame.

### TECHNICAL FIELD

The present invention relates to a portable safety ladder that can be folded and transported, and more specifically, to a portable safety ladder that can prevent safety accidents by preventing the worker's fall, the ladder's toppling, and the ladder's slipping, which are the main causes of accidents involving portable ladders, and can reduce the volume and weight of the ladder so that the ladder can be conveniently carried and transported.

### BACKGROUND ART

A portable ladder is widely used in various construction sites, telecommunication construction sites, fruit farms, and the like.

Generally, when working at heights, a scaffolding device or an aerial work platform is fixedly installed at the work site. and then works are done.

However, when it is difficult to install a scaffold or an aerial work platform due to a narrow work site and, or when it is necessary to perform works while moving, a portable ladder is mainly used.

FIG. 1 shows an example of a step ladder as one of conventional portable ladders.

The step ladder (hereinafter referred to as an ‘A-type ladder’) illustrated in FIG. 1 is configured such that a first frame 20 and a second frame 30 form an A-shape. Each of the frames has step plates 22 or 33 installed horizontally at regular intervals.

The A-type ladder has advantages in that it is simple in structure, easy to fold, and easy to transport to a required location.

However, the A-type ladder illustrated in FIG. 1 does not have a separate work platform. Therefore, there is a risk of a worker falling during work.

In addition, since the ladder structure is unstable, there is a high risk of safety accidents due to the toppling or slipping of the ladder.

According to Korean industrial accident statistics, the number of deaths related to ladder accidents in the past five years (2018 to 2022) is 176, and 95% of the accidents are related to portable ladders.

To solve the above problems, a so-called platform ladder, which is equipped with a working platform on the ladder, has been developed and is being used.

As shown in FIG. 2, the platform ladder is provided with a work platform 15 having a certain area at the top of the step 22, and is provided with a handrail 18 so that a worker can hold it with his hand and climb up.

The platform ladder has an advantage in that it is safer than the A-type ladder by having a safety platform.

However, the platform ladder shown in FIG. 2 is not only bulky and heavy, but also has a structure that cannot be folded, thereby making it inconvenient to carry and transport the platform ladder.

As a result, workers at the actual work site are avoiding the use of the platform ladder.

Meanwhile, there is a ladder equipped with outriggers among the conventional ladders. However, this ladder has a disadvantage that it can be used only when the floor is flat and a certain amount of space is secured.

### DETAILED DESCRIPTION OF THE INVENTION

### Technical Field

In view of the problems inherent in the related art, it is an object of the present invention to provide a portable safety ladder that adopts advantages of an A-type ladder and a platform ladder while compensating for their disadvantages.

Another object of the present invention is to provide a portable safety ladder that can maintain the workability and transportability as advantages of an A-type ladder while ensuring the safety as an advantage of a platform ladder.

A further object of the present invention is to provide a portable safety ladder that can prevent accidents caused by workers losing balance, ladder toppling, and ladder slipping while making it easy to move and store the ladder.

A further object of the present invention is to provide a portable safety ladder that can minimize the weight thereof while maintaining an advantage of a platform ladder.

A further object of the present invention is to provide a portable safety ladder that can enhance work efficiency during continuous moving works by making the ladder as lightweight as possible.

A further object of the present invention is to provide a portable safety ladder that can minimize the volume when folded, making it easy to carry and transport the ladder.

A further object of the present invention is to provide a portable safety ladder that can eliminate the need to install a separate handrail to improve safety when a worker moves up and down along the ladder.

A further object of the present invention is to provide a portable safety ladder that can prevent the worker's feet from coming off a work platform during works and can prevent tools or equipment on the work platform from falling down.

A further object of the present invention is to provide a portable safety ladder that can improve an existing outrigger structure to ensure that outriggers are stably supported even when an obstacle exists or a space is narrow.

### Means to Solve the Task

In order to achieve these objects, there is provided a portable safety ladder, including: a ladder body including a first frame and a second frame that, when the ladder is unfolded, are spread apart from each other about an upper hinge axis to maintain an A-shape, and when the ladder is folded, are completely folded about the hinge axis; and an upper safety rail provided in a loop shape on an upper portion of the ladder body to prevent a worker riding on a work platform of the ladder body from falling down, wherein the upper safety rail is provided above a pair of base members that are assembled to move up and down with respect to the first frame, and the upper safety rail is provided in a rotary type, so that when the ladder is folded, the upper safety rail is completely folded toward the second frame side and comes into close contact with the second frame.

The upper safety rail may be provided with a cushioned shoulder pad so that the ladder body can be folded and carried on a shoulder.

Step plates may be horizontally provided at regular intervals on the first frame, and struts may be provided instead of the step plates on the second frame so that a worker can go up and down only on the side of the first frame.

Openings may be formed at regular intervals along a vertical direction in the first frame, openings may be formed at regular intervals along the vertical direction in the second frame, and openings may be formed at regular intervals along the vertical direction in the base member, so that a worker can go up and down by holding the frames through the openings.

Each of the first frame and the second frame may be bent so as to spread outward from a middle of an overall height.

A foot stopper plate of a certain height may be provided around the work platform to prevent the worker's feet from leaving the work platform.

A pair of connecting rods may be rotatably provided at opposite ends of an entrance of the work platform, and the connecting rods may be connected to a loop-shaped intermediate handrail by an upper hinge so that when the ladder body is folded, the intermediate handrail rotates downward to allow the work platform to be completely folded.

On both sides of a lower portion of the work platform, support members may be obliquely provided to support the work platform when the work platform is unfolded.

In front of the entrance of the work platform, a level may be provided to indicate a horizontal state of the ladder.

On both sides of a lower end of each of the first frame and the second frame, active outriggers may be provided to stably support the ladder on a ground, an obstacle, or a vertical surface in conformity with a terrain and an obstacle on a floor.

Each of the outriggers includes outrigger legs provided to be folded on both sides of the first frame and the second frame, and locking parts configured to fix the outrigger legs supported on a ground, an obstacle, or a vertical surface.

The locking part may include a locking bar provided so that an end portion thereof corresponds to an upper surface of the outrigger leg while being rotatably installed on the ladder body above the outrigger leg, and configured to be folded toward the ladder body together with the outrigger leg, and a stopper configured to limit rotation of the outrigger leg supported on a ground by fixing an end portion of the locking bar to an upper surface of the outrigger leg.

The stopper may be movably installed at an end portion of the locking bar, the stopper may be elastically pressed by a return spring so as to make frictional contact with a bottom surface of a locking groove formed along a longitudinal upper surface of the outrigger leg, and the stopper may come into frictional contact with the bottom surface of the locking groove of the outrigger leg to fix the end portion of the locking bar to the outrigger leg when the outrigger leg is extended from the ladder body and supported on a ground, an obstacle or a vertical surface.

The outriggers may include two outriggers provided on both sides of a lower end of the first frame, and the two outriggers may be provided at a right angle with respect to each other.

The portable safety ladder may further include: a hollow first lower frame provided below the first frame so that the first frame can be inserted into and removed from the first lower frame; and a hollow second lower frame provided below the second frame so that the second frame can be inserted into and removed from the second lower frame, wherein the first frame and the second frame may be height-adjustable by the first lower frame and the second lower frame.

Each of the first frame and the second frame may be provided with a scale display portion for indicating the height of the ladder when adjusting an elevation height.

Each of the first lower frame and the second lower frame may be obliquely bent outward in a middle portion thereof.

The portable safety ladder may further include: castors provided on both sides of a lower portion of the second lower frame.

### Effect of the Invention

The portable safety ladder according to the present invention can have the advantages of an A-type ladder and the platform ladder while complementing for their disadvantages.

In other words, the portable safety ladder can maintain the workability and transportability as advantages of an A-type ladder while ensuring the safety as an advantage of a platform ladder.

In particular, since it is possible to secure safety equivalent to that of the existing platform ladder, the portable safety ladder can prevent accidents caused by workers losing balance, ladder toppling, and ladder slipping.

In addition, the portable safety ladder can minimize the volume when folded, making it easy to carry, transport and store the ladder.

In addition, since the frame of the portable safety ladder is provided with the multiple openings, the weight of the ladder can be reduced, thereby improving the convenience of transport.

In addition, since the worker can hold the frame using the openings formed in the frame when going up and down, there is no need to install a separate guard rail on the frame.

In addition, since the support member is configured as a lift type and the upper safety rail is configured as a rotary type, the overall height can be lowered when the ladder is folded.

In addition, by providing a cushioned shoulder pad at the center of the upper safety rail, the worker can conveniently carry the ladder on his shoulder when moving short distances.

In addition, since the work platform is a fully foldable structure, the width can be minimized when the ladder is folded.

In addition, by providing a foot stopper plate on the edge of the work platform, the worker's feet do not leave the work platform during work, preventing a toppling accident.

In addition, tools or equipment on the work platform can be prevented from falling down.

In addition, by providing a level on the front of the work platform, the worker can check the horizontal state of the work platform when climbing onto the work platform.

In addition, due to the structure of the active outriggers, the ladder can be stably fixed regardless of the terrain, objects, or obstacles on the floor.

### BRIEF DESCRIPTION OF THE DRAWINGS

FIG. 1 is a view showing an A-type ladder according to the prior art.

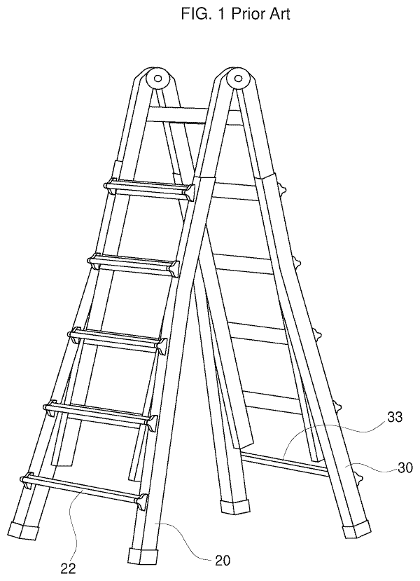

FIG. 2 is a view showing a platform ladder according to the prior art.

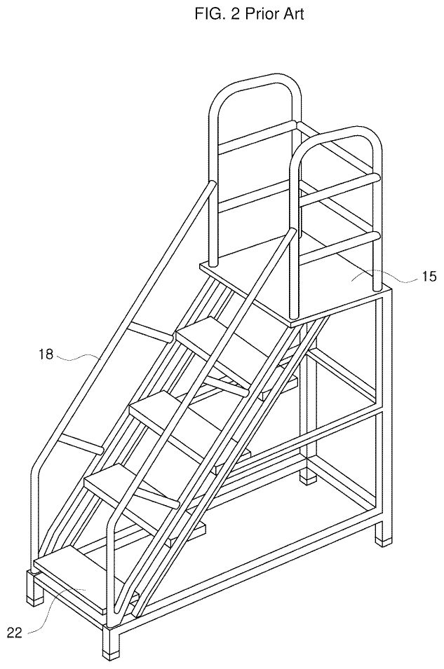

FIG. 3 is a perspective view of a portable safety ladder according to a first embodiment of the present invention.

FIG. 4 is a side view and a front view showing the safety ladder according to the first embodiment of the present invention in an unfolded state.

FIG. 5 is a side view and a front view showing the safety ladder according to the first embodiment of the present invention in a folded state.

FIG. 6 is a view showing a work platform and an upper safety rail of the safety ladder according to the first embodiment of the present invention.

FIG. 7 is a view showing an extended state of outriggers of the safety ladder according to the first embodiment of the present invention.

FIG. 8 is a view showing a state of use of the outriggers of the safety ladder according to the first embodiment of the present invention.

FIG. 9 is a side view and a front view showing an unfolded state of the safety ladder according to a second embodiment of the present invention.

FIG. 10 is a side view and a front view showing a folded state of the safety ladder according to the second embodiment of the present invention.

### BEST MODE TO IMPLEMENT THE INVENTION

Preferred embodiments of the present invention will now be described in detail with reference to the accompanying drawings.

### First Embodiment

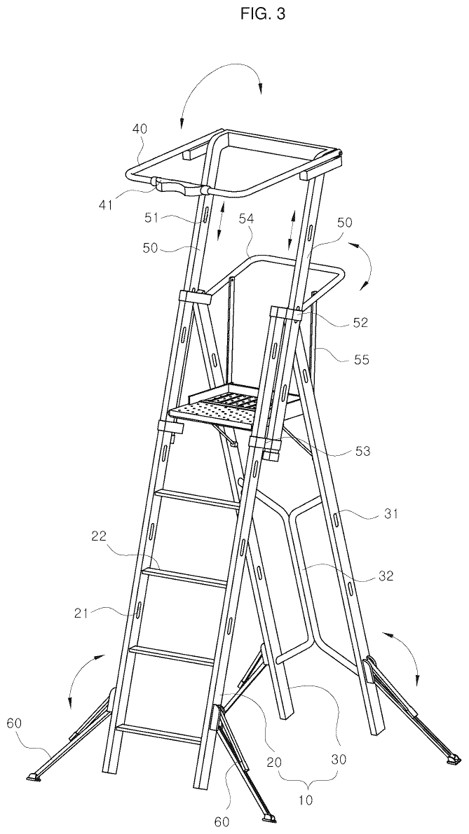

FIGS. 3 to 8 show a portable safety ladder according to a first embodiment of the present invention.

The portable safety ladder according to the first embodiment of the present invention includes: a ladder body 10 including a first frame 20 and a second frame 30 that, when the ladder is unfolded, are spread apart from each other about an upper hinge axis to maintain an A-shape, and when the ladder is folded, are completely folded about the hinge axis; and an upper safety rail 40 provided in a loop shape on an upper portion of the ladder body 10 to prevent a worker riding on a work platform 15 of the ladder body 10 from falling down, wherein the upper safety rail 40 is provided above a pair of base members 50 that are assembled to move up and down with respect to the first frame 20.

The base member 50 is fixed to and released from the first frame 20 by an upper fixing member 52 and a lower fixing member 53.

The upper fixing member 52 and the lower fixing member 53 may adopt various fixing means such as a locking pin and a clamp.

In addition, the upper safety rail 40 is provided in a rotary type, so that when the ladder is folded, the upper safety rail 40 is completely folded toward the second frame 30 side and comes into close contact with the second frame 30.

That is, the upper safety rail 40 according to the present invention is horizontally unfolded toward the first frame 20 side where the worker boards when in use, and is completely folded toward the second frame 30 side in the opposite direction to the direction in which the worker boards when the ladder is folded.

In addition, the upper safety rail 40 is provided as an integral part with the elevating base member 50, and is raised and lowered together with the base member 50 when the ladder is unfolded and folded.

The above structure makes it possible to minimize the overall height when the ladder is folded.

The upper safety rail 40 is provided with a cushioned shoulder pad 41 so that the ladder body 10 can be folded and carried on the shoulder.

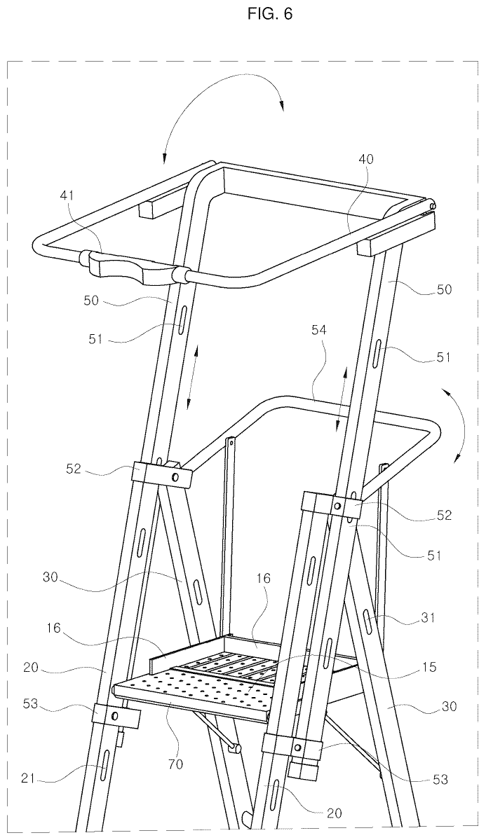

The shoulder pad 41 is formed in an arc shape to fit the shoulder area of the human body, as shown in FIG. 6.

This allows the worker to transport the ladder by carrying the shoulder pad 41 on the shoulder after folding the ladder, thereby reducing the worker's labor intensity.

Further, in the portable safety ladder according to the present invention, step plates 22 are horizontally provided at regular intervals on the first frame 20, and struts 32 instead of the step plates are provided on the second frame 30.

That is, the portable safety ladder according to the present invention has a structure in which a worker can only go up and down on one side of the ladder, i.e., on the first frame 20 side.

This fundamentally prevents two workers from riding on the ladder at the same time.

In addition, openings 21 are formed at regular intervals along the vertical direction in the first frame 20, openings 31 are formed at regular intervals along the vertical direction in the second frame 30, and openings 51 are formed at regular intervals along the vertical direction in the base member 50.

In this regard, the openings 21, 31 and 51 are formed in a long slot shape so that the worker can hold the frame with his/her hand through the openings.

In addition, the openings 21, 31 and 51 are formed to correspond to the arrangement distance of the step plates 22.

With the above structure, the worker can go up and down along the step plates 22 while holding the frame with his/her hand through the openings 21, 31 and 51.

As a result, there is no need to install a separate handrail on the frame for the safety of the worker when going up and down, and the weight of the frame can be reduced to make the ladder lighter.

The frames and the base member according to the present invention are preferably made of aluminum, and the surfaces thereof are preferably hard anodized.

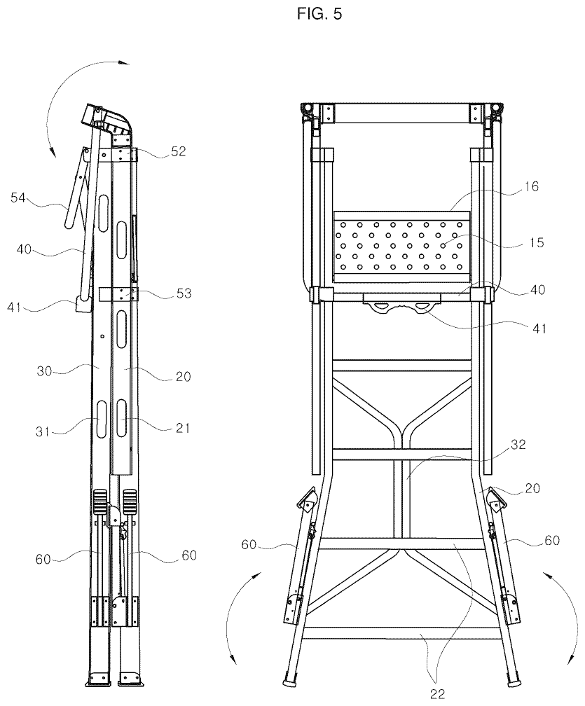

In addition, the first frame 20 and the second frame 30 according to the present invention are bent so as to spread outward at the middle of the overall height, as shown in FIG. 5.

With the above structure, the ladder can be stably supported on the ground when it is unfolded.

In addition, as shown in FIG. 6, the portable safety ladder according to the present invention includes a foot stopper plate 16 of a certain height provided around the work platform 15.

This prevents the worker's feet from being separated from the work platform 15 during high-altitude works, thereby preventing a falling or toppling accident.

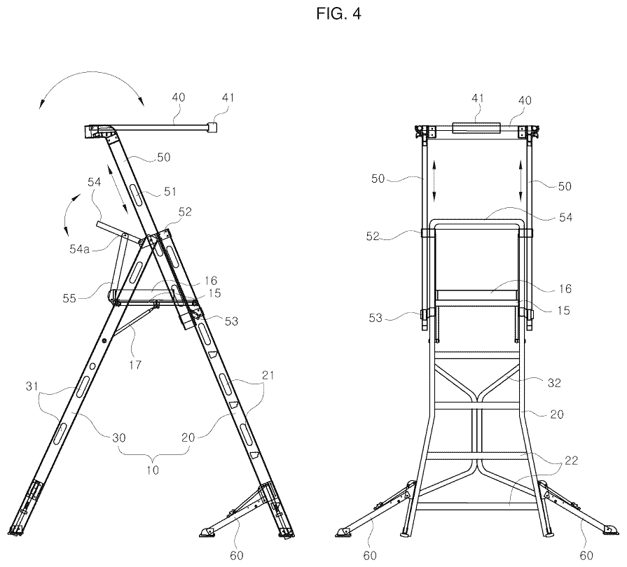

In addition, as shown in FIGS. 3 and 4, the portable safety ladder according to the present invention includes a pair of connecting rods 55 rotatably provided at opposite ends of an entrance of the work platform 15. The connecting rods 55 are connected to a loop-shaped intermediate handrail 54 by an upper hinge 54a.

By the above structure, when the ladder body 10 is folded as shown in FIG. 5, the intermediate handrail 54 rotates downward so that the work platform 15 is completely folded. This allows the width of the ladder to be minimized when the ladder is folded.

In addition, on both sides of the lower portion of the work platform 15, support members 17 are obliquely provided to support the work platform 15 when the work platform 15 is unfolded.

By the support members 17, the worker can be stably supported when the worker boards the work platform 15.

In addition, as shown in FIG. 6, the portable safety ladder according to the present invention further includes a level 70 provided in front of the entrance of the work platform 15 to indicate a horizontal state of the ladder.

By the level 17, the worker can visually check the horizontal state of the ladder before boarding the work platform 15.

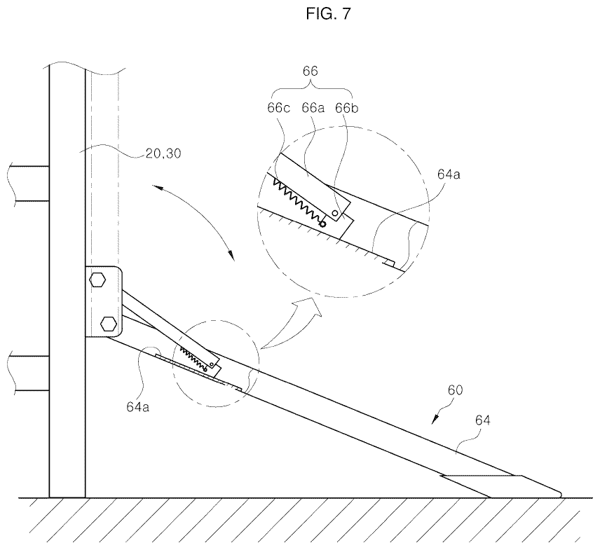

As illustrated in FIG. 7, the portable safety ladder according to the present invention further includes active outriggers 60 on both sides of the lower ends of the first frame 20 and the second frame 30, which are fixed to the ground, an obstacle, or a vertical surface in conformity with the terrain and obstacles on the floor.

Each of the outriggers 60 includes outrigger legs 64 provided to be folded on both sides of the first frame 20 and the second frame 30, and locking parts 66 configured to fix the outrigger legs 64 supported on the ground, an obstacle, or a vertical surface.

In this regard, the locking part 66 includes: a locking bar 66a provided so that an end portion thereof corresponds to an upper surface of the outrigger leg 64 while being rotatably installed on the ladder body 10 portion above the outrigger leg 64, and configured to be folded toward the ladder body 10 together with the outrigger leg 64; and a stopper 66b configured to limit rotation of the outrigger leg 64 supported on the ground by fixing the end portion of the locking bar 66a to the upper surface of the outrigger leg 64.

The locking bar 66a is rotatably installed on the ladder body 10 so as to have the same folding direction as the outrigger leg 64, and the end portion thereof is configured to correspond to the upper surface of the outrigger leg 64.

In particular, it is configured to be received in the locking groove 64a formed along the longitudinal upper surface of the outrigger leg 64.

In this regard, since the locking bar 66a has the same folding direction as the outrigger leg 64, the locking bar 66a is folded together with the outrigger leg 64 toward the ladder body 10.

The stopper 66b is movably installed at the end portion of the locking bar 66a. The stopper 66b thus installed fixes the end portion of the locking bar 66a to the outrigger leg 64 while making frictional contact with a bottom surface of a locking groove 64a of the outrigger leg 64.

In addition, the stopper 66b is elastically pressed by a return spring 66c so as to make frictional contact with the bottom surface of the locking groove 64a of the outrigger leg 64.

The elastically pressed stopper 66b comes into frictional contact with the bottom surface of the locking groove 64a of the outrigger leg 64 when the outrigger leg 64 is extended from the ladder body 10 and supported on the ground, etc.

Therefore, the end portion of the locking bar 66a is fixed to the outrigger leg 64.

This enables the locking bar 66a to support the upper surface of the outrigger leg 64. As a result, the outrigger leg 64 can be locked while being supported on the ground, etc.

In this regard, the locking bar 66a and the stopper 66b are configured to move along the locking groove 64a of the outrigger leg 64 and come into frictional contact with the bottom surface of the locking groove 64a.

As a result, the outrigger leg 64 can be locked regardless of the extending angle of the outrigger leg 64.

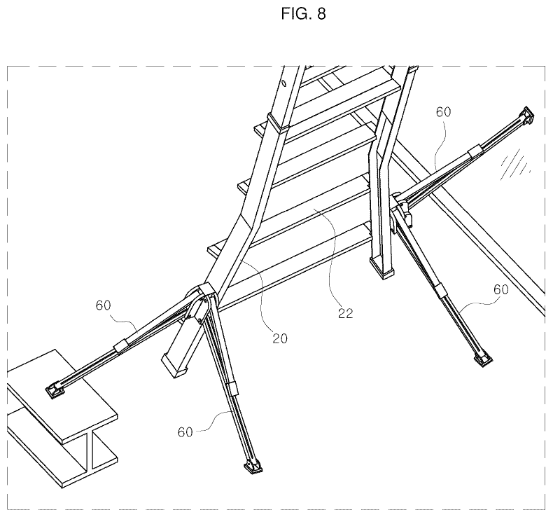

By the structure of the outrigger, as shown in FIG. 8, the ladder can be stably supported even when there is an obstacle or the space is narrow.

In particular, the outrigger can be supported on a vertical surface rather than the floor.

In addition, two outriggers 60 are provided on both sides of the lower end of the first frame 20.

In this regard, the two outriggers 60 are preferably provided at a right angle with respect to each other as shown in FIG. 8.

With the above structure, the ladder can be supported more stably.

Hereinafter, the process of using the portable safety ladder according to the present invention will be described with reference to FIGS. 4 and 5.

First, as shown in FIG. 5, the ladder in a folded state is unfolded into an A-type by spreading apart the first frame 20 and the second frame 30.

Then, the work platform 15 is also unfolded to stably support the first frame 20 and the second frame 30.

Then, the upper safety rail 40 is unfolded horizontally toward the first frame 20 where a worker will board, and is then fixed.

Next, the upper fixing member 52 and the lower fixing member 53 are released, the base member 50 is lifted upward, and the base member 50 is fixed.

Next, the outrigger 60 is unfolded and fixed to the ground, an obstacle, or a vertical surface.

In this state, the worker climbs up the ladder along the step plates 22 while holding first frame 20 with his/her hand through the openings 21 formed in the first frame 20.

At this time, the worker moves his/her upper body inward of the upper safety rail 40 and boards the work platform 15.

When the work is completed, the worker goes down along the ladder while holding the first frame 20 through the openings 21, and then releases the fixing state of the upper fixing member 52 and the lower fixing member 53.

Then, the base member 50 is lowered to the original position and fixed, and the outrigger 60 is retracted to the original position.

Then, when the first frame 20 and the second frame 30 are overlapped with each other, the work platform 15 is also folded.

Then, when the upper safety rail 40 is rotated to its original position, i.e., toward the second frame 20, and pressed against the second frame 30, the folding of the ladder is completed.

### Second Embodiment

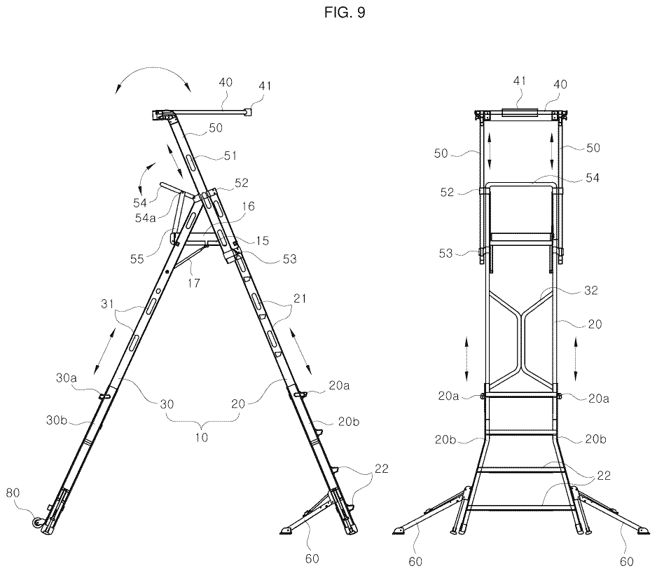

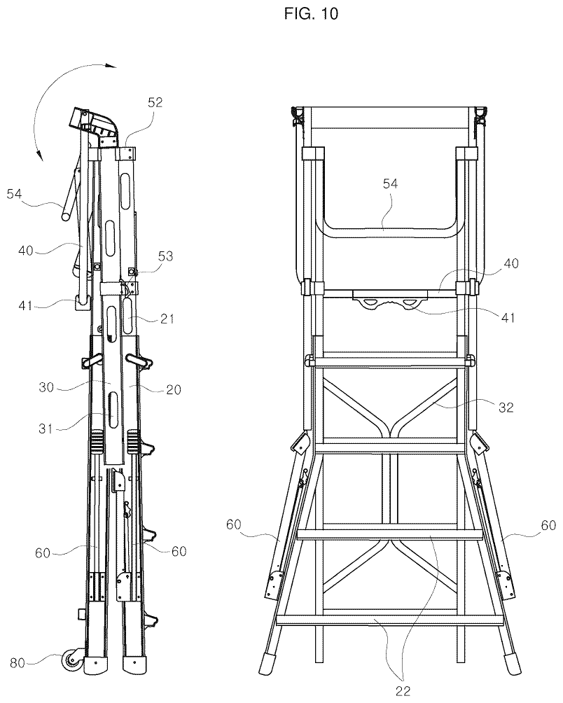

FIGS. 9 and 10 show a portable safety ladder according to a second embodiment of the present invention.

The portable safety ladder according to the second embodiment of the present invention is capable of adjusting the height of the frame in the first embodiment described above, and is more convenient to transport.

The portable safety ladder according to the second embodiment of the present invention further includes a hollow first lower frame 20b provided below the first frame 20 so that the first frame can be inserted into and removed from the first lower frame 20b.

The portable safety ladder further includes a hollow second lower frame 30b provided below the second frame 30 so that the second frame can be inserted into and removed from the second lower frame 30b.

In addition, the first lower frame 20b is provided with a fixing member 20a for fixing and releasing the first frame 20, and the second lower frame 30b is provided with a fixing member 30a for fixing and releasing the second frame 30.

By the above structure, the elevation heights of the first frame 20 and the second frame 30 can be adjusted.

In addition, each of the first frame 20 and the second frame 30 is provided with a scale display portion for indicating the height of the ladder when adjusting the elevation height.

Each of the first lower frame 20b and the second lower frame 30b is obliquely bent outward in the middle portion thereof. This enables the ladder to be stably supported.

Castors 80 are further provided on both sides of the lower portion of the second lower frame 30b.

The folded ladder can be conveniently moved on a flat floor surface by using the castors 80.

Since other details are the same as in the first embodiment described above, duplicate descriptions will be omitted.

While the preferred embodiments of the present invention have been described above, the present invention is not limited to the above-described embodiments. Various modifications and changes may be made without departing from the scope and spirit of the present invention defined in the claims.

1. A portable safety ladder, comprising:
a ladder body (10) including a first frame (20) and a second frame (30) that, when the ladder is unfolded, are spread apart from each other about an upper hinge axis to maintain an A-shape, and when the ladder is folded, are completely folded about the hinge axis; and
an upper safety rail (40) provided in a loop shape on an upper portion of the ladder body (10) to prevent a worker riding on a work platform (15) of the ladder body (10) from falling down,
wherein the upper safety rail (40) is provided above a pair of base members (50) that are assembled to move up and down with respect to the first frame (20), and
the upper safety rail (40) is provided in a rotary type, so that when the ladder is folded, the upper safety rail (40) is completely folded toward the second frame (30) side and comes into close contact with the second frame (30).

2. The portable safety ladder of claim 1, wherein the upper safety rail (40) is provided with a cushioned shoulder pad so that the ladder body (10) can be folded and carried on a shoulder.

3. The portable safety ladder of claim 1, wherein step plates (22) are horizontally provided at regular intervals on the first frame (20), and struts (32) are provided instead of the step plates on the second frame (30) so that a worker can go up and down only on the side of the first frame (20).

4. The portable safety ladder of claim 3, wherein openings (21) are formed at regular intervals along a vertical direction in the first frame (20), openings (31) are formed at regular intervals along the vertical direction in the second frame (30), and
openings (51) are formed at regular intervals along the vertical direction in the base member (50), so that a worker can go up and down by holding the frames through the openings.

5. The portable safety ladder of claim 4, wherein each of the first frame (20) and the second frame (30) is bent so as to spread outward from a middle of an overall height.

6. The portable safety ladder of claim 1, wherein a foot stopper plate (16) of a certain height is provided around the work platform (15) to prevent the worker's feet from leaving the work platform (15).

7. The portable safety ladder of claim 6, wherein a pair of connecting rods (55) are rotatably provided at opposite ends of an entrance of the work platform (15), and
the connecting rods (55) are connected to a loop-shaped intermediate handrail (54) by an upper hinge (54a) so that when the ladder body (10) is folded, the intermediate handrail (54) rotates downward to allow the work platform (15) to be completely folded.

8. The portable safety ladder of claim 7, wherein on both sides of a lower portion of the work platform (15), support members (17) are obliquely provided to support the work platform (15) when the work platform (15) is unfolded.

9. The portable safety ladder of claim 8, wherein in front of the entrance of the work platform (15), a level (70) is provided to indicate a horizontal state of the ladder.

10. The portable safety ladder of claim 1, wherein on both sides of a lower end of each of the first frame (20) and the second frame (30), active outriggers (60) are provided to stably support the ladder on a ground, an obstacle, or a vertical surface in conformity with a terrain and an obstacle on a floor.

11. The portable safety ladder of claim 10, wherein each of the outriggers (60) includes outrigger legs (64) provided to be folded on both sides of the first frame (20) and the second frame (30), and locking parts (66) configured to fix the outrigger legs (64) supported on a ground, an obstacle, or a vertical surface.

12. The portable safety ladder of claim 11, wherein the locking part (66) includes a locking bar (66a) provided so that an end portion thereof corresponds to an upper surface of the outrigger leg (64) while being rotatably installed on the ladder body (10) above the outrigger leg (64), and configured to be folded toward the ladder body (10) together with the outrigger leg (64), and a stopper (66b) configured to limit rotation of the outrigger leg (64) supported on a ground by fixing an end portion of the locking bar (66a) to an upper surface of the outrigger leg (64).

13. The portable safety ladder of claim 12, wherein the stopper (66b) is movably installed at an end portion of the locking bar (66a), the stopper (66b) is elastically pressed by a return spring (66c) so as to make frictional contact with a bottom surface of a locking groove (64a) formed along a longitudinal upper surface of the outrigger leg (64) and
the stopper (66b) comes into frictional contact with the bottom surface of the locking groove (64a) of the outrigger leg (64) to fix the end portion of the locking bar (66a) to the outrigger leg (64) when the outrigger leg (64) is extended from the ladder body (10) and supported on a ground, an obstacle or a vertical surface.

14. The portable safety ladder of claim 13, wherein the outriggers (60) include two outriggers (60) provided on both sides of a lower end of the first frame (20), and
the two outriggers (60) are provided at a right angle with respect to each other.

15. The portable safety ladder of claim 1, further comprising:
a hollow first lower frame (20b) provided below the first frame (20) so that the first frame can be inserted into and removed from the first lower frame (20b); and a hollow second lower frame (30b) provided below the second frame (30) so that the second frame can be inserted into and removed from the second lower frame (30b), wherein the first frame (20) and the second frame (30) are height-adjustable by the first lower frame (20b) and the second lower frame (30b).

16. The portable safety ladder of claim 15, wherein each of the first frame (20) and the second frame (30) is provided with a scale display portion for indicating the height of the ladder when adjusting an elevation height.

17. The portable safety ladder of claim 15, wherein each of the first lower frame (20b) and the second lower frame (30b) is obliquely bent outward in a middle portion thereof.

18. The portable safety ladder of claim 15, further comprising:
castors (80) provided on both sides of a lower portion of the second lower frame (30b).
